(19) United States
(12) Patent Application Publication
(10) Pub. No.: US 2002/0177796 A1
(43) Pub. Date: Nov. 28, 2002

(54) Back-mountable massage device

(76) Inventor: Jeong-Joo Suh, Seoul (KR)

Correspondence Address: CHRISTIE, PARKER & HALE, LLP, 350 WEST COLORADO BOULEVARD, SUITE 500, PASADENA, CA, 91105, US

(21) Appl. No.: 09/994,992

(22) Filed: Nov. 20, 2001

(30) Foreign Application Priority Data
May 25, 2001 (KR) 2001-28864

(51) Int. Cl. A61H 7/00

(52) U.S. Cl. 601/84

(57) ABSTRACT

A massage device includes a supporting cover having a main body, a shoulder supporting member and a neck supporting member, a first massaging device for massaging a back of the human body, a second massaging device for massaging the shoulder, a third massaging device for massaging the neck, and a driving part for driving and controlling the first, second and third massaging devices. The first massaging device is provided to the main body and moved along the back, the second massaging device is provided to the shoulder supporting member, and the third massaging device is provided to the neck supporting member.

### BACKGROUND OF THE INVENTION

1. Field of the Invention

The present invention relates to a massage device, and more particularly, to a massage device that can knead the human body such as the neck and shoulders in a state where it is mounted on the back, thereby obtaining a finger-pressure therapy effect while saving a massaging space.

2. Description of the Related Art

Generally, a massage device is used to obtain selected stroking, rubbing and/or kneading massaging effects of the human body to increase the blood flow and obtain muscle relaxation.

A body massage may be divided into three levels of rising intensities. The first level, known in the art as stroking, involves a smoothing action characterized by mild to medium pressure applied onto a body part being massaged. Stroking is meant to warm-up and thereby prepare the body part being massaged to the following massage levels. The second level, known in the art as rubbing, involves a pressing and rubbing action characterized by movement of the tissue and medium to high pressure applied on the body part being massage. Rubbing is meant to increase the blood flow in the body part being massaged. The third level, known in the art as kneading, involves a pressing and kneading actions characterized by high pressure applied onto the body part being massaged. Kneading is typically a deep and through muscle massage extends over a relatively prolonged time minutes or more.

Such massage devices may be categorized into a vibration-type massage device and a kneading/rubbing-type massage device. The vibration-type massage is designed to convert a rotation movement of a motor into a vibration movement of a massage head. The kneading/rubbing-type massage device is designed to convert a rotation movement into a rubbing/kneading movement of a massage element.

Generally, such a vibration-type massage device is a hand-held type so that the user can held and locate the device on a body part to be massaged. However, the vibration-type massage cannot sufficiently provide the massage effect as it repeats its vibration.

In addition, such a rubbing/kneading-type massage device should be associated with a body supporting apparatus such as a chair or bed such that the user can use it in a state where the user's body is located and stuck onto the body supporting apparatus. Therefore, the conventional rubbing/kneading-type massage device has a problem that the body part to be massage is limited to a specific part such as the waist and the back that can be located on the body supporting apparatus.

### SUMMARY OF THE INVENTION

Therefore, the present invention has been made in an effort to solve the above-described problems.

It is an objective of the present invention to provide a rubbing/kneading-type back-mountable massage device that can be used without being associated a body supporting apparatus such as a chair and a bed, thereby saving a space it occupies.

To achieve the above objectives, the present invention provides a massage device comprising a supporting cover having a main body, a shoulder supporting member and a neck supporting member, first massaging means for a back of the human body, the first massaging means being provided to the main body and moved along the back, second massaging means for massaging the shoulder, the second massaging means being provided to the shoulder supporting member, third massaging means for massaging the neck, the third massaging means being provided to the neck supporting member, and a driving part for driving and controlling the first, second and third massaging means.

The massage device may further comprise a power transmission means disposed between the first, second and third massage means and the driving part to convert a rotational motion of the driving part into a linear reciprocal motion.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is an exploded perspective view of a massage device according to a preferred embodiment of the present invention;

FIG. 2 is an enlarged view illustrating a variety of assembled massage parts constituting a massage device according to a preferred embodiment of the present invention;

FIG. 3 is a partly enlarged perspective view of a driving part and a power transmission means of a massage device according to a preferred embodiment of the present invention;

FIG. 4 is an enlarged perspective of a first massage means of a massage device according to a preferred embodiment of the present invention;

FIG. 5 is a sectional view of a massage device mounted on the back according to a preferred embodiment of the present invention;

FIG. 6 is an enlarged perspective of a second massage means of a massage device according to a preferred embodiment of the present invention; and

FIG. 7 is an enlarged perspective of a third massage means of a massage device according to a preferred embodiment of the present invention.

### DETAILED DESCRIPTION OF THE PREFERRED EMBODIMENTS

A preferred embodiment of the present invention will be described in detail with reference to the accompanying drawings.

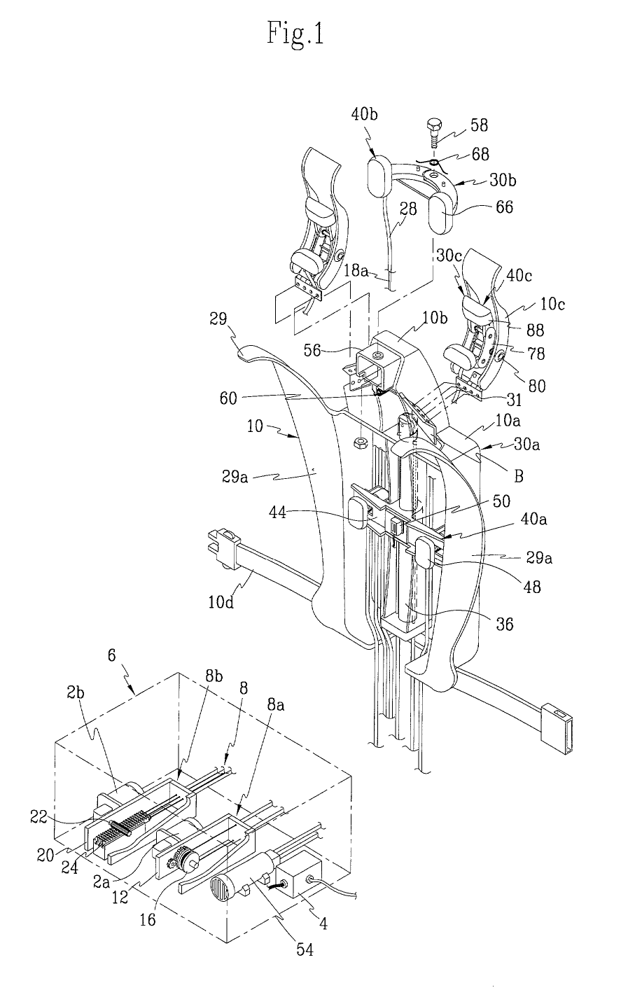

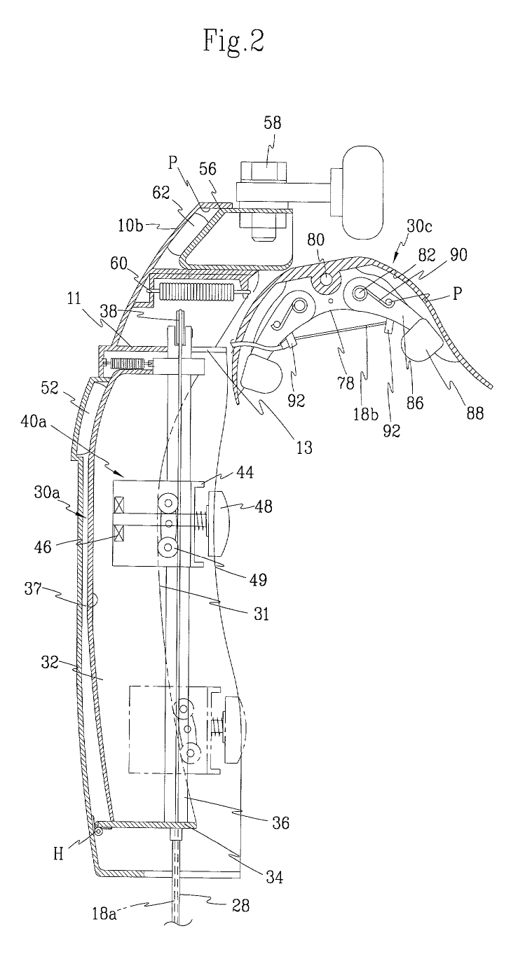

FIGS. 1 and 2 show a massage device according to a preferred embodiment of the present invention. The inventive massage device comprises a driving part 6 having a driving source such as a first and second motors 2a and 2b and a controller 4 for controlling the operation of the motors 2a and 2b; a power transmission means 8 for converting a rotational motion of the motors 2a and 2b into a linear reciprocal motion; a supporting cover 10 designed to be suitable to a human body so that it can put on the back of a user to be massaged; and a variety of massage means for massaging each part of the human body, the massage means being mounted on the supporting cover 10 and connected to the power transmission means 8.

The controller 4 controls a massage time and a variety of massage modes such as a stroking, rubbing and kneading modes.

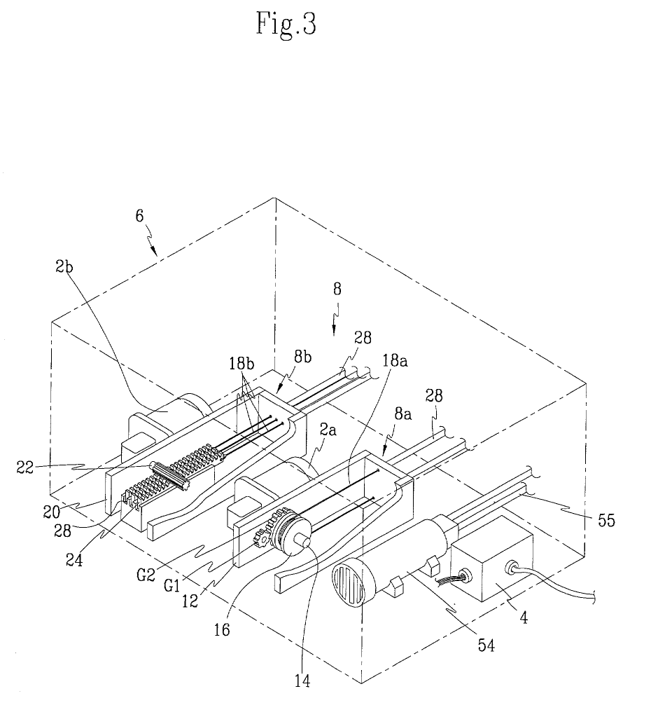

The power transmission means 8 transmits driving force created by the first and second motors 2a and 2b to each massage means. As shown in FIG. 3, the power transmission part 8 comprises a first power transmission means 8a for transmitting the driving force from the first motor 2a to a massage means and a second power transmission means 8b for transmitting the driving force from the second motor 2b to other massage means.

As shown in FIG. 3, the first power transmission means 8a comprises a driving shaft 14 rotatably supported by a pair of supporting blocks 12 facing each other, a roll 16 fixedly mounted around the driving shaft 14 and rotated therewith, and double rows of wires 18a and 18b wound on the roll 16 several times and extended out of the driving part 6.

The driving shaft 14 receives a rotational power from a driving gear G1 rotated by the first motor 2a and a driven gear G2 engaged with the driving gear G1.

A sensor(not shown) is provided in one side of the supporting block 12 to detect the RPM of the roll 16 and a detected signal is transmitted to the motor 2a through a control part so that the roll and pinion can be reversibly rotated in various RPMs

The second power transmission means 8b comprises a pinion 22 rotatably supported on a pair of supporting blocks 20 to receive driving force from the second motor 2b, a rack 24 reciprocally moving by the rotational motion of the pinion 22, and a plurality of wires 18b, 19b, and 20b coupled to the proximal end of the rack 24 and extended out of the driving part 6.

Mounted on one end of the pinion 22 is a sensor (not shown) for detecting the RPM of the pinion 22. A signal detected by the sensor is transmitted to the motor 2 via the controller 4 and controls the rotational direction and RPM of the pinion 22.

The rack 24 is designed to move along a guide member 28 disposed between the supporting blocks 20. Accordingly, the rack 24 pulls or releases the wires 18b, 19b and 20b.

Preferably, portions of the wires 18a, 19a, 18b, 19b and 20b, which are disposed out of the first and second power transmission means 8a and 8b, are covered with protecting covers 28.

The above-described massage device is operated in a variety of modes according to the adjustment of a massage mode switch (not shown).

The supporting cover 10, in which the variety of massage means operated by the first and second power transmission means 8a and 8b is mounted, comprises a main body 10a having left and right supporting members 29a and 29b designed having a similar curvature to that of a specific human body part on which they are to be put on, a neck supporting member 10b formed on the top of the main body 10a between the left and right supporting members 29a and 29b, and a pair of shoulder supporting members 10c (see FIG. 1) mounted on the top of the main body 10a at both sides of the neck supporting member 10b by hinge members 31.

Provided on both lower sides of the main body 10a is a waist belt 30 by which the main body 10a of the supporting cover 10 can be closely supported on the human body.

Preferably, a shoulder belt (not shown) may be further provided on the left and right supporting parts 29a and 29b.

The variety of massage means are mounted in the supporting cover 10. The variety of massage means comprise a back massage part 30a installed in the main body 10a to massage the back, a neck massage part 30b installed in the neck supporting member 10b to massage the neck and a shoulder massage part 30c installed in the shoulder supporting members 10c to massage the shoulders.

The back massage part 30a receives massage power from the first motor 2a via the first power transmission means 8a, and the neck and shoulder massage parts 30b and 30c receive massage power from the second motor 2b via the second power transmission part 8b.

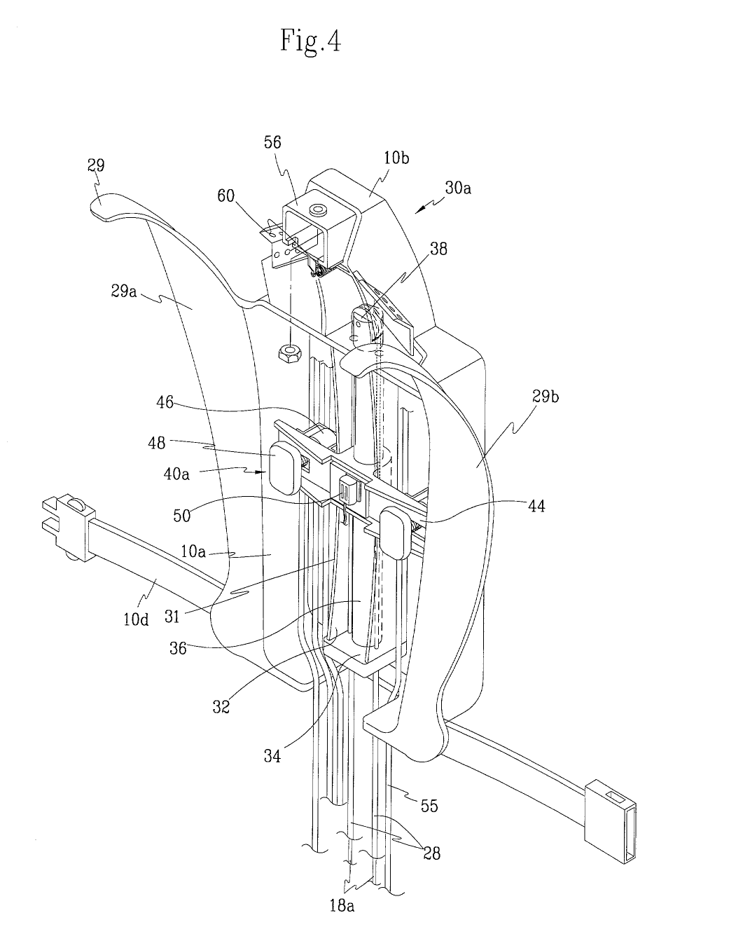

As shown in FIGS. 2, 4 and 5, the back massage part 30a comprises a pair of supporting members 32 fixed inside the main body 10a in a longitudinal direction, a lower plate 34 fixed on the lower side of the supporting member 32 and coupled on the inner surface of the main body 10 by a hinge member H, a rear plate 37 fixed on a rear corner of the supporting members 32 and located on the inner surface of the main body 10a, an air bag 52 disposed between the main body 10a and the rear plate 37, a guide member 36 fixed on the rear plate 34, and a roller 38 mounted on the upper side of the guide member 36.

The upper portion of the guide member 38 is disposed in a slot 13 formed on the upper surface 11 of the main body 10a so that it can move forward and rearward. The guide member 36 may be biased by an elastic member 39 rearward.

The supporting member 32 is designed having a curvature identical to that of the back of the human body. A back massage member 40a is disposed on the guide members 36 such that it can ascend and descend along the curvature 31 of the supporting members 32.

The back massage member 40a comprises a slider 44 fitted in the guide member 36 and coupled to one of the wires 18a and 19a, the slider ascending and descending as the wire coupled released and wound, plural press parts 48 disposed on both sides of the slider 44 and performing the massage operation according to a solenoid 46, a guide roller 49 for allowing the solenoid 46 to move along the curvature as the slider 44 ascends and descends, and a vibrator 50 for vibrating the press parts 48 by vibrating the slider 44.

The elastic member 60 lets the guider roller contact the curvature 31 when the slider 44 moves along the curvature 31.

In addition, the air bag 52 disposed between the upper rear surface of the supporting members 32 and the main body 10a biases the massage part 40a to the back of the human body so that the massage part 40a closely contacts the massage part 40a regardless of the shape of the back.

The air bag 52 is connected to an air injector 54 mounted on the driving part 6 through a tube 55 so as to be supplied with air from the air injector 54. As the air injector 54, a small compressor may be used.

A thermo-heater (not shown) that can be electrically heated may be mounted on the slider 44 so as to enhance the massage efficiency by providing a thermotherapy effect.

The operation of the back massage part 30a will be described in detail hereinafter.

When the first motor 2a rotates, the rotational motion is converted into a reciprocal motion by the first power transmission means 8a so that the wires 18a and 19a pulls and pushes the back massage member 40a, thereby ascending and descending the slider 44.

At this point, the solenoid 46 operates the press parts 48 according to the control of the control part 4 such that the press parts 48 knead the back. In addition, when the vibrator 50 vibrates at a predetermined cycle under the control of the control part 4, since the vibration is transmitted to the press parts 48, the press parts 48 provides the kneading and vibration effects to the back.

As shown in FIGS. 1, 2 and 6, the neck massage part 30b comprises a pocket P integrally formed with the neck supporting member 10b, a supporting member 56 movably disposed in the pocket P, a neck massage member 40b hingedly fixed on the top of the supporting member 56 by a fixing member 58, and an elastic member 60 disposed between the supporting member 56 and the neck supporting member 10b to bias the supporting member 56 toward the neck supporting member 10b.

In addition, disposed between the neck supporting member 10b and the supporting member 56 is an air bag 62 connected to an air injection member 54 through a tube 55 so that air can be injected into the air bag (see FIG. 1). By the air bag, the neck massage member performs its massage action in a state where it adheres closely to the neck.

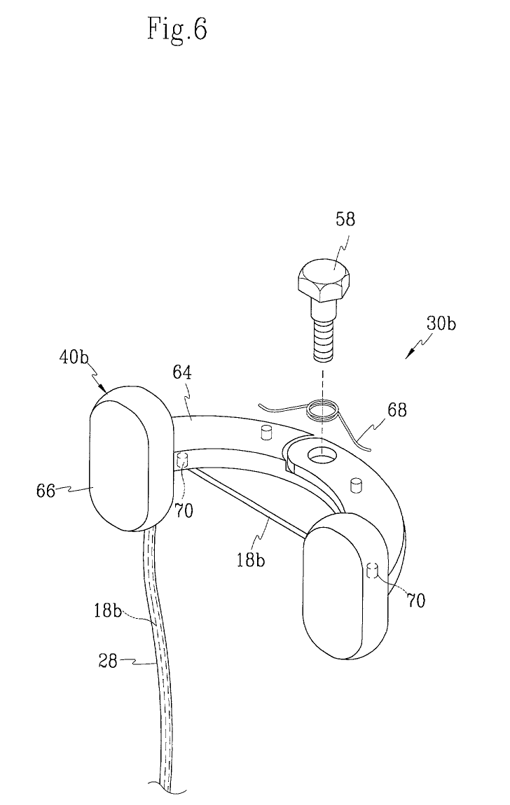

As shown in FIG. 6, the neck massage member 40b comprises a pair of arms 64 arc-shaped, proximal ends of which are pivotally fixed each other by a fixing member 58, a pair of pressing members 66 performing the massage operation while contacting the human body, the pressing members 66 being mounted on distal ends of the arms 64, respectively, and a torsion spring 68 for biasing the arms 64 to the widened position of the arms 64.

The torsion spring 68 has a middle portion wound around the fixing member 58 and both ends elastically supported on projections 65 and 67 formed on the arms 64.

Supporting projections 70 are formed on bottoms of the both arms 64, respectively. One end of the wire 18b of the second power transmission means 8b is hung on one of the supporting projections 70, and the other end of the wire 18b is hung on the other of the supporting projections 70.

In operation, when the motor is driven, the rotational motion of the motor 2 is converted into the linear reciprocal motion by the second power transmission means 8 to pull or release the wire 18b.

When the wire 18b is pulled by the power transmission part 8, the arms 64 move toward each other to knead the neck, and when the wire W3 is released, the arms 64 are widened from each other by the elastic force of the torsion spring 68. This operation is repeated as the motor 2 rotates forward and rearward.

In addition, the shoulder massage part 30c is provided on the left and right shoulder supporting members 10c. The left and right shoulder supporting members 10c is connected by the hinge members 31 to a bracket B fixed on the main body 10a.

Since both of the shoulder supporting members 10c has an identical structure to each other, only one of them will be described hereinafter.

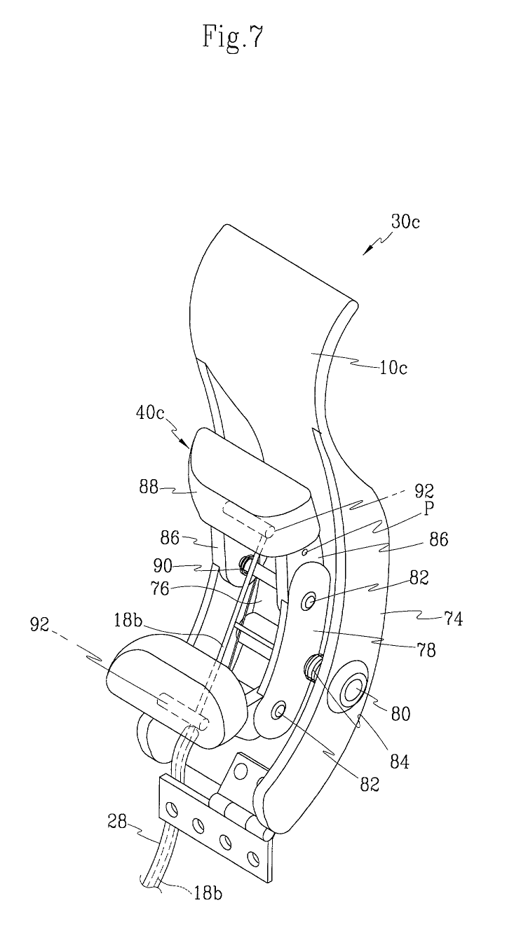

As shown in FIG. 7, the shoulder supporting member 10c is arc-shaped to enclose shoulder. On both sides of the shoulder supporting member 10c, longitudinal sidewalls 74 are formed to define a groove 76 with the shoulder supporting member 10c.

The shoulder massage part 30c is installed in the groove 76 and supported by the longitudinal sidewalls 74. The shoulder massage part 30c comprises a pair of supporting members 78, a fixing member 80 disposed between and fixed on the longitudinal sidewalls 74 to slidably support the supporting members 78 between the longitudinal side walls 74, and shoulder massage members 40c pivotally fixed on both ends of the supporting members 78 by a pivot shaft 82 (see FIGS. 2 and 7).

Elastic members 84 are disposed between the longitudinal sidewalls and the supporting members 78.

Each of the shoulder massage members 40c comprises a first pair of arms 86 each having a first end fixed on the pivot shaft 82 between the supporting members 78, a pressing member 88 mounted on the second ends of the arms 86 to perform the massage operation while contacting the body, and a torsion spring 90 for widening the pressure members 78.

The torsion spring 90 has a first end fixed on the pivot shaft 82 and a second end fixed on a pin 91 formed on the arm 86.

Disposed between the first pair of arms and between the second pair of arms are respectively a pair of fixing members 92. The wire W4 is wound around one of the fixing members 92, then extended and fixed to the other end of the fixing members 92.

When the second motor 2b is driven, the wires 19b and 20b are pulled and released by the second power transmission means 8 converting the rotational motion of the motor 2 into the linear reciprocal motion.

At this point, when the wires 19b and 20b are pulled, the first and second pairs of arms 86 move toward each other to knead the shoulders, and when the wires 19b and 20b are released, the first and second pairs of arms 86 move away from each. This operation is repeated as the second motor 2b rotates forward and rearward.

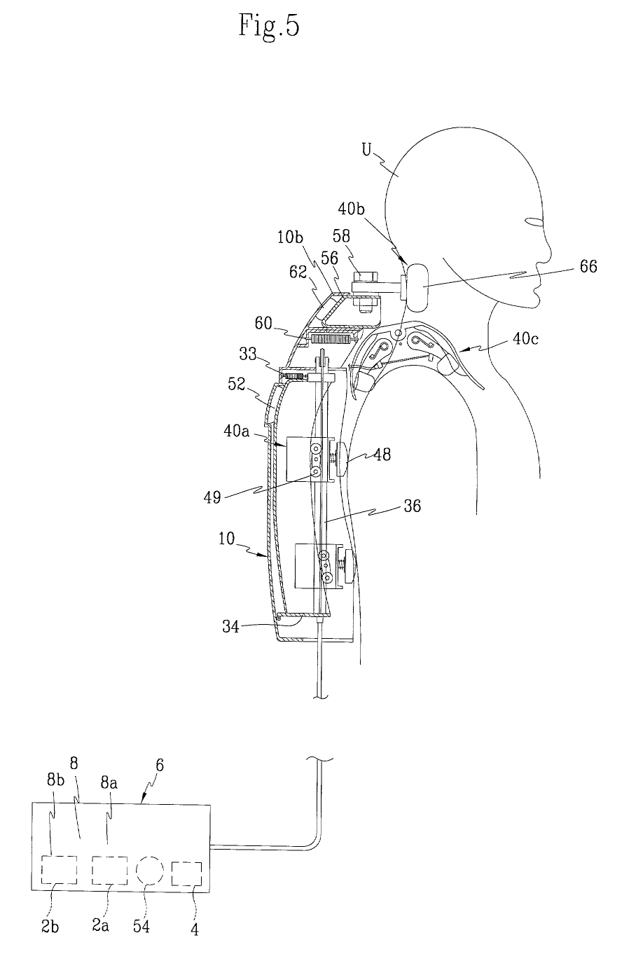

In use of the above-described massage device, it is first put on the back, and then waist belt 10d and the shoulder belt (not shown) are properly fastened for the user U as shown in FIG. 5.

Next, the air injection member 54 is operated to inject air into the air bags 52 and 62 provided in the back and neck massage parts 30a and 30b, thereby making the massage device closely contact the body.

After the massage device is completely put on the user U as described above, electric power is turned On to operate the first and second motors 2a 2b, and a massage mode is selected by adjusting the massage mode switch (not shown) or the controller 4.

The driving force of the first motor 2a is transmitted to the first power transmission means 8, and is than converted into linear reciprocal motion. That is, the rotational motion of the motor 2 is transmitted to the pinion 22, and the rack 24 linearly moves along the pinion 22, thereby pulling or releasing the wires 18a and 19a. By this operation of the wires 18a and 19a, the back massage part 40b kneads the back as it ascends and descends. In addition, the vibrator 50 vibrates the plate 44 at a predetermined frequency to massage the back. The kneading and vibrating can be properly controlled by the controller 4.

At the same time, the rotational motion of the second motor 2b is transmitted to the pinion 22 via the second power transmission means 8b to reciprocally move the rack 24. By the reciprocal motion of the rack 24, the wires 18b, 19b and 20b coupled to the rack 24 is wounded and released, thereby the arms 64 and 86 and the pressing parts 66 and 88 are moved toward each other or widened by the torsion springs 68 and 90, thereby performing the rubbing type massage.

To stop the massage operation, the electric power is turned Off, and the waist belt 10d and the should belt are released, after which the shoulder supporting member 10c is turned out, thereby removing the massage device from the body.

As described above, since the massage device is used in a state where it is put on the body, it is convenient to get the massotherapy, while saving a space.

While this invention has been described in connection with what is presently considered to be the most practical and preferred embodiments, it is to be understood that the invention is not limited to the disclosed embodiments, but, on the contrary, is intended to cover various modifications and equivalent arrangements included within the spirit and scope of the appended claims.

What is claimed is:

1. A massage device comprising:
a supporting cover having a main body, a shoulder supporting member and a neck supporting member;
first massaging means for massaging a back of the human body, the first massaging means being provided to the main body and moved along the back;
second massaging means for massaging a shoulder of the human body, the second massaging means being provided to the shoulder supporting member;
third massaging means for massaging a neck of the human body, the third massaging means being provided to the neck supporting member; and
a driving part for driving and controlling the first, second and third massaging means.

2. A massage device of claim 1 further comprising a power transmission part disposed between the first, second and third massaging means and the driving part to convert a rotational motion of the driving part into a linear reciprocal motion.

3. A massage device of claim 2 wherein the power transmission part comprises first power transmission means for transmitting the driving force from a motor to the first massaging means and a second power transmission means for transmitting the driving force from a motor to the second and third massaging means.

4. A massage device of claim 3 wherein the first power transmission means comprises a driving shaft rotatably supported by a pair of supporting blocks facing each other to receive the driving force from the motor, a roll fixedly mounted around the driving shaft and rotated therewith, and a wire wound on the roll several times and extended out of the driving part.

5. A massage device of claim 3 wherein the second power transmission means comprises a pinion supported by a pair of supporting blocks facing each other to receive the driving force from the motor, a rack reciprocating by the rotational force of the pinion, and a plurality of wires connected to a proximal end of the rack and extended out of the driving part.

6. A massage device of claim 3 wherein sensors are provided in the first and second power transmission means to detect a roll and pinion RPMs respectively and detected signals are respectively transmitted to the motors through a control part so that the roll and pinion can be forward and reverse rotated in various RPMs.

7. A massage device of claim 1 wherein the supporting cover comprising a main body having right and left portions designed having a similar curvature to that of a specific body part on which they are to be put on, a neck supporting part fixed on a top of the main body, and a pair of shoulder supporting parts hingedly fixed on the top of the main body at both sides of the neck supporting part by a connection member like a hinge and positioned in leaving a space from the shoulder.

8. A massage device of claim 1 wherein the first massaging means comprises a pair of supporting members fixed inside the main body in a longitudinal direction, a lower plate fixed on the lower side of the supporting member and coupled on the inner surface of the main body by a hinge member, a rear plate fixed on a rear corner of the supporting members and located on the inner surface of the main body, a guide member fixed on the rear plate, a roller mounted on the upper side of the guide member, and a back massage member for massaging the back while moving along the guide member.

9. A massage device of claim 8 wherein the back massage member comprises a slider fitted in the guide member and coupled to one of the wires, the slider ascending and descending as the wire coupled released and wound, plural press parts disposed on both sides of the slider and performing the massage operation according to a solenoid, and a guide roller for allowing the solenoid to move along the curvature as the slider ascends and descends. a vibrator for vibrating the press parts by vibrating the slider.

10. A massage device of claim 9 wherein the back massage member further comprises a vibrator for vibrating the press parts by vibrating the slider.

11. A massage device of claim 9 wherein the back massage member further comprises a thermo-heater that can be electrically heated may be mounted on the slider so as to enhance the massage efficiency by providing a thermotherapy effect.

12. A massage device of claim 8 wherein the back massage member further comprises an air bag disposed between the main body and the rear plate,

13. A massage device of claim 1 wherein the second massaging means comprises a neck supporting member defining a pocket, a supporting member movably disposed in the pocket, and a neck massage member hingedly fixed on the top of the supporting member.

14. A massage device of claim 13 wherein the second massaging means further comprises an air bag disposed between the neck supporting member and the supporting members.

15. A massage device of claim 13 wherein the neck massage member comprises a pair of arms arc-shaped, proximal ends of which are pivotally fixed each other by a fixing member, a pair of pressing members performing the massage operation while contacting the human body, the pressing members being mounted on distal ends of the arms, respectively, and a torsion spring for biasing the arms to the widened position of the arms.

16. A massage device of claim 1 wherein the third massaging means comprises a pair of supporting members, a fixing member disposed between and fixed on the longitudinal sidewalls to slidably support the supporting members between the longitudinal side walls, and shoulder massage members pivotally fixed on both ends of the supporting members by a pivot shaft.

17. A massage device of claim 16 wherein each of the shoulder massage members comprises a first pair of arms each having a first end fixed on the pivot shaft between the supporting members, a pressing member mounted on the second ends of the arms to perform the massage operation while contacting the body, and a torsion spring for widening the pressure members.

18. A massage device of claim 1 wherein the kneading, vibration and rubbing of the first, second and third massaging means are controlled by a controller.

19. A massage device of claim 1 wherein a massage time and a massage mode of the first, second and third massaging means are controlled by a control part.

20. A massage device of claim 20 wherein the control part comprises a massage mode switch for selecting the massage mode.
